(19) United States
(12) Patent Application Publication
(10) Pub. No.: US 2025/0158558 A1
(43) Pub. Date: May 15, 2025

(54) VERTICAL PHOTOVOLTAIC SYSTEM AND METHOD FOR INSTALLING SUCH A SYSTEM

(71) Applicant: ENGIE, Courbevoie (FR)

(72) Inventor: Luc BARROVECCHIO, Courbevoie (FR)

(21) Appl. No.: 18/729,710

(22) PCT Filed: Jan. 24, 2024
(86) PCT No.: PCT/EP2023/051639

§ 371 Date: Jul. 17, 2024

(30) Foreign Application Priority Data
Jan. 24, 2022 (FR) FR2200571

(51) Int. Cl. H02S 20/10

(52) U.S. Cl. CPC H02S 20/10

(57) ABSTRACT

The invention relates to a vertical photovoltaic system (200) comprising:
at least one bifacial rectangular photovoltaic module (101), each such module having:
two sides, referred to as “short sides”,
two other sides, referred to as “long sides”, the length of which is greater than or equal to a length of at least one short side,
the module being oriented such that a short side is arranged facing the ground (102) when the system is in the installed position;
at least two support posts (103) for supporting the photovoltaic module, at least one such post having:
a first portion (104) configured to be secured to at least one such photovoltaic module;
a second portion (105) configured to be secured to the ground; and
at least one securing means (106) for securing at least one such post to the long side of at least one such photovoltaic module in such a way that each photovoltaic module is directly connected, via its two long sides, to the securing means of two consecutive support posts.

### TECHNICAL FIELD OF THE INVENTION

The present invention relates to a vertical photovoltaic system and a method for installing such a system. It applies, in particular, to the field of the production of energy from renewable sources.

### STATE OF THE ART

In the field of the production of energy from renewable sources, the use of photovoltaic systems is an effective solution for transforming light energy into electrical energy. However, the installation of such systems must take certain constraints present in and dependent on the installation site into account. These constraints can be defined, in particular according to the surface area, topography, nature and use of the installation site.

In certain locations that could accommodate photovoltaic systems, there is a problem of space, especially with respect to agricultural lands. These sites therefore need to be shared between agriculture and the production of energy. When this distribution is effective then coactivity is established, corresponding to the coexistence between a major agricultural activity and an efficient production of energy by photovoltaic systems. This coactivity is referred to as “agrivoltaism”, also known as “Agri-PV” or “APV”.

The solutions of the prior art describe photovoltaic systems having a significant footprint. These systems comprise, in particular, photovoltaic modules arranged in “landscape” mode. These solutions do not take into consideration the need to reduce the footprint of the photovoltaic systems. Consequently, these systems have limited compatibility with sites with intense spatial constraints, and therefore with agrivoltaism.

In addition, the installation of photovoltaic systems as envisaged in the prior art requires a significant amount of materials such as steel or aluminium. For example, in the prior art the use of one or more horizontal structural elements with a considerable length arranged above the module and secured between two posts is essential for the stability of the system. Moreover, these upper horizontal elements cast a shadow on the module while the system is being used, causing a reduction in the solar radiation irradiating the modules and therefore a reduction in the efficiency of the system. The presence of one or more upper horizontal elements also diminishes the spatial and geometric adaptability of the photovoltaic systems.

The German utility model DE 20 2020 104 397 discloses a vertical photovoltaic system comprising at least one module secured on its largest side to a post. In this system, the photovoltaic panels are adjacent and juxtaposed to each other. Such a juxtaposition requires a very specific support “framework” comprising, in particular, at least two cross-members connecting the supporting posts. Japanese patent application JP 2002 076 416 discloses a photovoltaic system in which the modules are secured to the posts by their smallest side, and are therefore arranged vertically in a “landscape” format. This photovoltaic system comprises an upper horizontal structural bar.

In general, the vertical photovoltaic systems have a significant wind surface area and produce a lot of heat due to solar radiation. The resulting mechanical stresses, both in terms of resistance to wind loads, which can oscillate and exceed 300 kg per square metre, and in terms of thermal expansion, make complex, heavy and expensive structures necessary between the supporting posts of these photovoltaic systems. The connections of these structures with these posts involve, in turn, local stresses requiring local adjustments to the profiles of supporting posts or a general increased weight in their profile. This leads to an extremely complex design of these supporting posts and a high cost of materials, machining and manufacture. These problems are compounded when several photovoltaic panels are superposed one above the other to increase the photovoltaic production.

### DESCRIPTION OF THE INVENTION

The present invention aims to remedy all or part of these drawbacks.

To this end, according to a first aspect, the invention envisages a vertical photovoltaic system, which comprises:
at least one bifacial rectangular photovoltaic module, each module having:
two sides, referred to as “short sides”,
two other sides, referred to as “long sides”, the length of which is greater than or equal to a length of at least one short side;
at least two support posts for supporting the photovoltaic module, each such post having:
a first portion configured to be secured to at least one such photovoltaic module,
a second portion configured to be secured to the ground; and
at least one securing means for securing at least one such post to the long side of at least one such photovoltaic module;
each photovoltaic module being directly connected, via its two long sides, to the securing means of two consecutive support posts.

It is noted that the term “directly connected” means that there is no other photovoltaic module between a long side of a photovoltaic module and a post. It does not preclude the presence of connecting parts between the long side of a photovoltaic module and the post to which it is connected and which supports it.

Therefore, while it is counter-intuitive to increase the number of supporting posts for the same total surface area, the inventors have determined that the invention enables a paring down, reduction, or even an elimination, of the structure connecting two posts supporting the same photovoltaic module. The invention also enables a simplification of the design, profile and manufacture of these supporting posts, and a paring down of these posts. In addition, since the photovoltaic modules are supported on their two long sides, the bending forces exerted on these modules are reduced relative to a support on these two short sides, as well as their bending, such that their structural reinforcement elements can also be reduced, lessened or absent.

Thanks to the utilisation of the invention, additional support is provided to the module by securing a long side of the module to a post, enabling its layout in a configuration referred to as “portrait”. The system's resistance to mechanical stresses is therefore improved. In this way, a stable vertical fixed bifacial photovoltaic system is installed in the ground. The system also makes it possible to reduce the footprint, and in particular to increase compatibility with agricultural activity on the installation land. This system is therefore compatible with agrivoltaism. The system thus installed also has a low hydrological impact on the plants when it is installed on agricultural land.

In addition, the system is modular and therefore enables a simplified, rapid and flexible installation. Thus, the system can be easily adapted to the constraints inherent in the installation site and the constraints on use. For example, such a system is easily installed on a site with a slope. Furthermore, the replacement of a part or module, e.g. when damaged, is facilitated since the system can be easily and quickly disassembled and reassembled. Thus, when one section of the installation is damaged, the specific replacement of this section can be carried out without the rest of the installation having to be disassembled. These provisions also make it possible to use a considerable variety of photovoltaic modules, for example having different sizes or a specific organisation of the cell lines.

In some embodiments, the system comprises no horizontal structural element, connecting two posts, arranged above the short side of a photovoltaic module farthest from the ground. Thanks to these provisions, the quantity of installation materials is reduced. This lowers the cost of the installation, reducing its environmental impact.

In addition, the system enables improved management of the light irradiating the photovoltaic modules, reducing the shadows caused by the use of a more complex structure comprising, in particular, the upper horizontal element. In effect, the system enables maximum irradiation in front of and behind the modules. The amount of electricity produced is therefore increased.

In some embodiments, the securing means has a plurality of attachment positions configured to position a module closer to or farther from the ground according to the attachment position height. Thanks to these provisions, the system can be adjusted based on the vertical constraints inherent in the use of the land, the surrounding crop and/or the device. For example, in zones where the installation site is subject to light winds, a mechanical resistance lower than a mechanical resistance suitable for a zone with strong winds can be applied. Thus, the height of the post can be adjusted for different wind zones so as to enable a larger or smaller distance between the attachments of the photovoltaic module. For example, in zones with low mechanical stresses, the attachments are on portions close to the middle of the long sides of the photovoltaic module. Whereas, for example, in zones with high mechanical stresses, the attachments are on portions farther from the middle of the long sides of the photovoltaic module. In particular, the posts do not need to have lengths greater than the height of the highest attachment point of the module. As a result, based on the mechanical stresses, posts with a variety of lengths are used.

In some embodiments, as least one securing means comprises:
at least one bolt and nut assembly,
at least one clip system,
at least one spring, and/or
at least one gripper.

Thanks to these provisions, securing the post to the photovoltaic module is made easier. In addition, these provisions make it possible to adjust the attachment according to the mechanical stresses applied to the photovoltaic system. For example, when the post comprises one or more oblong holes, the nut and bolt assembly allows a precise dimensional tolerance. For example, the clip system enables attachment via the rear of the securing frame of the module, thus preventing the module from detaching from the post.

In some embodiments, at least one post has a cross-sectional profile with the following shape:
symmetrical or asymmetrical H;
inclined H;
cross;
C;
F;
inclined T;
offset inclined T; or
inclined Z.

Thanks to these provisions, the system's ease of installation and mechanical resistance are improved. In addition, the system has a reduced vertical shadow on the rear surface of the module. Additionally, when the post is made of a material at least partially reflective, the cross-sectional profiles enable an optimum reflection of the sunlight on the photovoltaic module. This boosts the increased electricity production. Lastly, the cross-sectional profiles make it possible to facilitate the use of the securing means by increasing the compatibility between the post, the securing means and the module.

In some embodiments, the system comprises:
at least one cross member arranged under the short side of a photovoltaic module closest to the installation ground, and having extremities; and
at least two connecting means, each such connecting means being configured to secure an individual extremity of at least one such cross-member to a post, this cross-member being arranged and secured between at least two posts.

Thanks to these provisions, the cross-member makes it possible to improve the system's stability and mechanical resistance. Additionally, the cross-member makes it possible in particular, when it is arranged below and in contact with a module, to reinforce the vertical and height maintenance of the module subjected to gravity.

In some embodiments, at least one cross-member has a C- or inverted U-shaped cross-sectional profile.

Thanks to these provisions, there is no rim on the cross-member, which makes it possible to avoid the accumulation of, for example, dust or water at the area of contact between the photovoltaic module and the cross-member. This limits the accumulation of residues likely to form, for example, a shadow on the lower portion of the module and thus impair the increased electricity production. In addition, the risks of degradation linked to the accumulation of water likely to form, for example, moss or mould on the lower portion of the module are reduced.

In some embodiments, at least one cross-member is configured to at least partially enclose at least one post.

Thanks to these provisions, the system has a more compact overall structure, thus making it possible to strengthen the stability of the structure.

In some embodiments, at least one cross-member comprises an upper rim in contact with the module and a lower rim configured to hold electrical cables connected to the photovoltaic module. Thanks to these provisions, the electrical cables are protected and oriented according to predefined constraints on use of the photovoltaic system.

In some embodiments, at least one connecting means comprises at least one intermediate attachment portion configured to complete the enclosure around at least one post.

Thanks to these provisions, the securing of the cross-member to the post is strengthened.

In some embodiments, at least one connecting means comprises at least one L-shaped intermediate attachment portion comprising:
an upper portion parallel to the long sides of the module and configured to be secured to a post; and
a lower portion, perpendicular to the upper portion and to the post, and configured to support the cross-member.

Thanks to these provisions, the support of the module is reinforced, making it possible to limit the mechanical stresses due to gravity and exerted on the first means for securing the module to posts. In some embodiments, the securing means between at least one post and at least one module is a sliding link type.

Thanks to these provisions, the securing module is easily installed or changed, thus allowing a reduction in the installation or changeover time.

In some embodiments, at least one post and/or at least one cross-member is at least partially made of a light-reflecting material.

Thanks to these provisions, light is reflected onto the modules, thus making it possible to boost the increased electricity production of the system.

According to a second aspect, the invention envisages a method for installing a vertical photovoltaic system, which comprises:
a step of positioning at least a first support post for supporting the photovoltaic module, at least one such first post having:
a distal portion, and
a proximal portion;
a step of securing the distal portion of at least one such first post to the ground;
a step of positioning at least one bifacial rectangular photovoltaic module, each such photovoltaic module having:
two sides, referred to as “short sides”, and
two other sides, referred to as “long sides”, the length of which is greater than or equal to a length of at least one short side;
a step of positioning at least a second support post for supporting the photovoltaic module;
a step of securing a distal portion of at least one such second post to the ground; and
a step of securing each proximal portion of two such consecutive posts to each long side of at least one such photovoltaic module;
   such that each photovoltaic module is directly connected, via its two long sides, to the securing means of two support posts.

As the particular aims, advantages and features of the method that is the subject of the invention are similar to those of the device that is the subject of the invention, they are not repeated here. According to a third aspect, the invention envisages using at least one securing means and at least one photovoltaic module support post for installing at least one vertical photovoltaic system that is the subject of the invention.

As the particular aims, advantages and features of the use that is the subject of the invention are similar to those of the device that is the subject of the invention, they are not repeated here.

### BRIEF DESCRIPTION OF THE FIGURES

Other advantages, aims and particular features of the invention will become apparent from the non-limiting description that follows of at least one particular embodiment of the device and method that are the subjects of the present invention, with reference to drawings included in an appendix, wherein:

FIGS. 1 to 6 represent, schematically and respectively, in a front view, six particular embodiments of the system that is the subject of the invention;

FIG. 7 represents, schematically and in a front view, a particular embodiment of a post comprised in a particular embodiment of the system represented in FIG. 6;

FIGS. 8 to 10 represent, schematically and respectively, in a front view, a sixth, seventh and eighth particular embodiments of the system that is the subject of the invention;

FIGS. 11 to 25 represent, schematically and respectively, in a top view and in cross-section, a tenth to twenty-fourth particular embodiments of a system that is the subject of the invention;

FIG. 26 represents, schematically, in a side view and in cross-section, two particular embodiments of a cross-member comprised in a system that is the subject of the invention;

FIG. 27 represents, schematically, in a side view and in cross-section, three particular embodiments of a cross-member comprised in a system that is the subject of the invention;

FIGS. 28 to 31 represent, schematically, in a side view and in cross-section, particular embodiments of a cross-member comprised in a system that is the subject of invention;

FIGS. 32 and 33 represent, schematically, in a top view and in cross-section, two particular embodiments of a cross-member comprised in a system that is the subject of the invention;

FIG. 34 represents, schematically, in a top view and in cross-section, a particular embodiment of a cross-member represented in FIG. 33 and a post comprised in a system that is the subject of the invention;

FIG. 35 represents, schematically, in a top view and in cross-section, a particular embodiment of a cross-member comprised in a system that is the subject of the invention;

FIG. 36 represents, schematically, in a top view and in cross-section, a particular embodiment of a cross-member represented in FIG. 35 and a post comprised in a system that is the subject of the invention;

FIGS. 37 and 38 represent, schematically, in a top view and in cross-section, two particular embodiments of a cross-member represented in FIG. 8 and an enclosure comprised in a system that is the subject of the invention;

FIG. 39 represents, schematically, in a top view and in cross-section, a twenty-fifth particular embodiment of a system that is the subject of the invention;

FIGS. 40 to 42 represent, schematically, in a top view, three particular embodiments of a system that is the subject of the invention;

FIG. 43 represents, schematically, in a top view, a particular embodiment of two cross-members comprised in a system that is the subject of this invention;

FIGS. 44 and 45 represent, schematically, in a top view, two particular configurations of a particular embodiment of a system that is the subject of the invention;

FIG. 46 represents, in the form of a logical diagram, steps utilised in a particular embodiment of the method that is the subject of the invention; and

FIG. 47 represents, schematically, in a top view, a particular embodiment of the system that is the subject of this invention.

### DESCRIPTION OF THE EMBODIMENTS

The present description is given in a non-limiting way, in which each characteristic of an embodiment can be combined with any other characteristic of any other embodiment in an advantageous way.

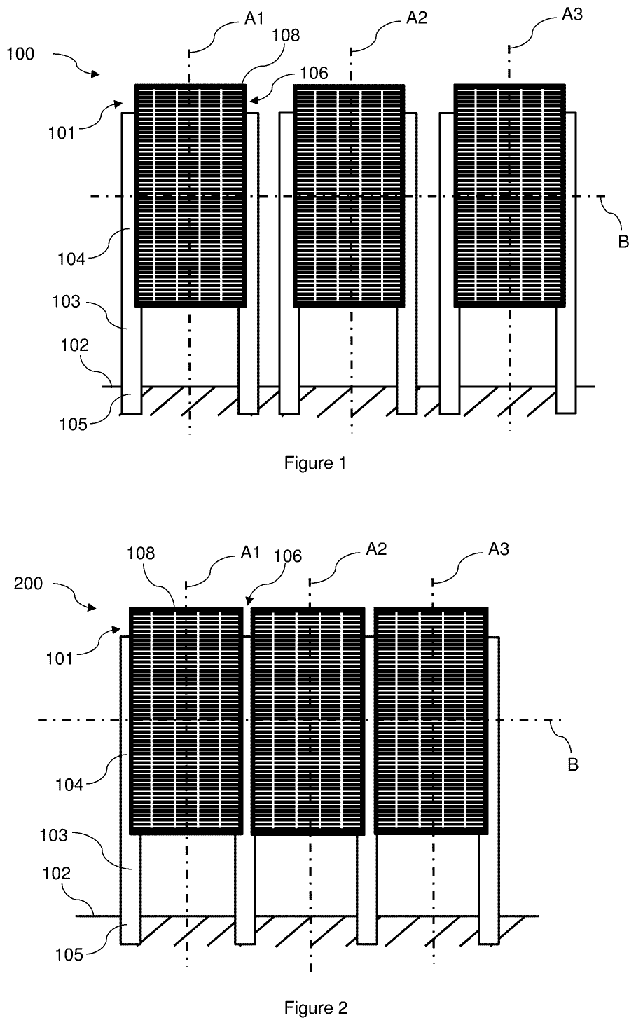

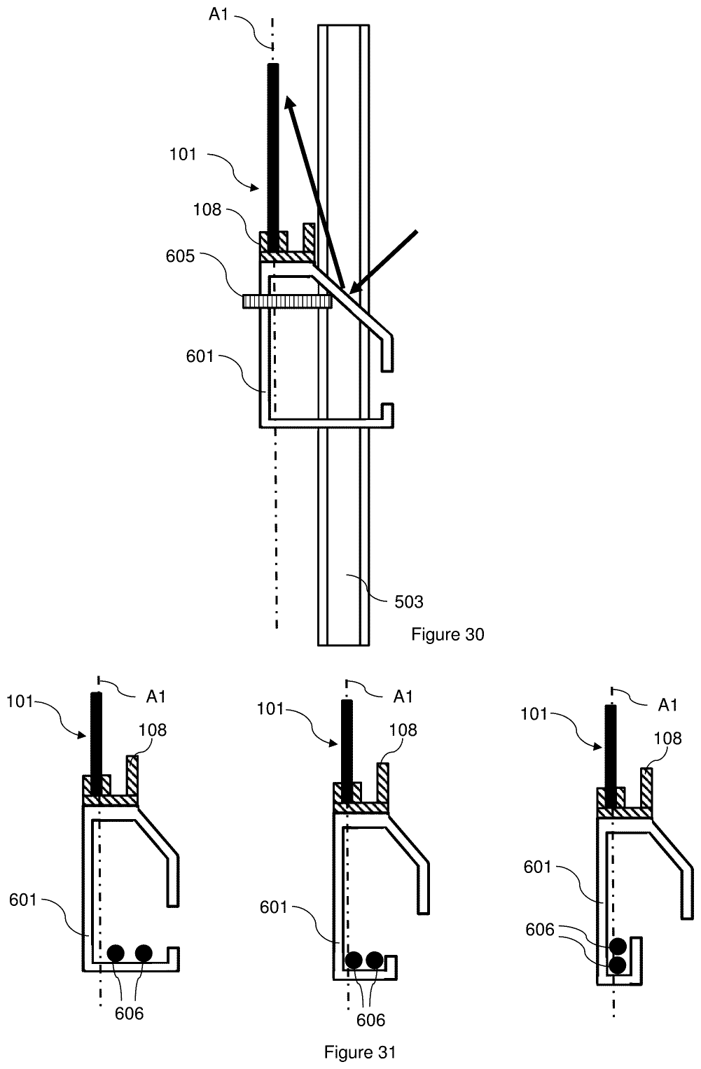

Throughout the description, the term “upper” or “top” refers to being located at the top in FIGS. 1 to 10 and 26 to 31, and “bottom” or “lower” to being located at the bottom in these FIGS. 1 to 10 and 26 to 31. The term “behind” refers to being located behind the plane of the figures, and “in front” to being located in front of the plane of the figures. The terms “vertical” and “horizontal” flow from these definitions. The systems shown in FIGS. 1 to 6 and 8 to 10 each have three vertical planes, perpendicular to the plane of the figures and including the centres of the two short sides respectively of the three photovoltaic modules. The intersection of the plane of the figures and these vertical planes define axes A1, A2 and A3. The systems shown in FIGS. 1 to 6 and 10 also have a first horizontal plane perpendicular to the plane of the figures and including the centres of the two long sides of the photovoltaic modules. The intersection of the plane of the figures and the first horizontal plane defines an axis B. The systems shown in FIGS. 6, 8 and 9 also have a second horizontal plane perpendicular to the plane of the figures and including the centres of the extremities of a cross member. The intersection of the plane of the figures and the second horizontal plane defines an axis C. The term “internal to the module” refers to being located close to or oriented towards the axis A1, A2 or A3 traversing the module, and “external” to being located farther away from this axis or oriented to the opposite of this axis. The term “proximal” refers to being located close to or oriented towards the axis B, and “distal” to being located farther from or oriented to the opposite of this axis. The lengths are defined parallel to axes A1, A2 and A3, and the widths are defined perpendicular to the plane of the figures.

The following definitions are noted here:

The term “increased electricity production” refers to an increase in the production of electricity, for example due to a larger amount of solar energy reaching the photovoltaic cells of the module. The term “bifacial module” refers to a module producing electricity on both of its faces. The faces of a module are the two surfaces having the largest dimension. A bifacial module allows the light on its front face and its back face to be transmitted to its photovoltaic cells. The photovoltaic cells use the light on both of their faces to produce electricity. In general, there is a junction box on the back face of the module, and the power generated by the back face is usually less than the power generated by the front face.

The term “facing the ground” refers to an installation configuration in which one short side of the photovoltaic module is closer to the ground than the other short side of the photovoltaic module.

The term “C-shaped” refers to a general shape having:
a support side, which supports an element and is substantially horizontal, also referred to as proximal side;
a side opposite the support side, which does not support an element and is substantially horizontal, also referred to as distal side;
the support side and the opposite side being connected by two sides, these two sides corresponding to a front side and a back side, the front side or the back side being at least partially free.

The term “U-shaped” refers to a general shape having:
a support side, which supports an element and is substantially horizontal, also referred to as proximal side;
a side opposite the support side, which does not support an element and is substantially horizontal and partially free, also referred to as distal side;
the support side and the opposite side being connected by two sides, these two sides corresponding to a front side and a back side.

Note that the figures are not to scale. It is also noted that, in all the embodiments, each photovoltaic module is directly connected, via its two long sides, to the securing means of two consecutive support posts. In some embodiments (not shown), at least two superposed photovoltaic modules can be directly connected, by their long sides, to the same two consecutive support posts.

FIG. 1 shows a schematic view of an embodiment of the system 100 that is the subject of the invention.

FIG. 1 shows that the vertical photovoltaic system 100 comprises:
at least one bifacial rectangular photovoltaic module 101, each such photovoltaic module 101 having:
two sides, referred to as “short sides”,
two other sides, referred to as “long sides”, the length of which is greater than or equal to a length of at least one short side.

The photovoltaic module 101 is oriented such that a short side is arranged facing the ground 102 when the system 100 is in the installed position.

Each system 100 also comprises at least two support posts 103 for supporting the photovoltaic module 101, at least one such post 102 having:
a proximal portion 104 configured to be secured to at least one such photovoltaic module 101; and
a distal portion 105 configured to be secured to the ground 102.

Each system 100 additionally also comprises at least one securing means 106 for securing at least one such post to the long side of at least one such photovoltaic module 101.

In some embodiments, such as that shown in FIG. 1, at least one photovoltaic module 101 is rectangular and has two long sides having a length that is longer than a length of at least one short side. In other words, the installed photovoltaic module 101 is in “portrait” mode. In some variants, at least one photovoltaic module 101 is rectangular and has two long sides having a length equal to a length of at least one short side, thus forming a square.

In some embodiments (not shown), at least two photovoltaic modules 101 are arranged vertically, one photovoltaic module 101 being arranged above the other photovoltaic module 101 in the installation configuration of the system 100. For example, the two photovoltaic modules 101 are supported by two posts 103. In other words, the two posts 103 are secured to the long sides of the photovoltaic modules 101, one post 103 being secured to two long sides and the other post 103 being secured to two other long sides.

In some embodiments, such as that shown in FIG. 1, each of the three modules 101 respectively comprises a separate axis of symmetry A1, A2 and A3.

It is noted that preferably, the nature of the photovoltaic module 101 is compatible with outdoor use. An outside environment defines, for example, thermal, mechanical, humidity or radiation constraints. In particular, the photovoltaic module 101 is installed on agricultural land. The nature of such a photovoltaic module 101 is known to the person skilled in the art.

FIG. 1 shows that the system 100 comprises a plurality of photovoltaic modules 101, each photovoltaic module 101 being secured to two support posts 103. In some embodiments, such as that shown in FIG. 1, the posts 103 are substantially vertical relative to the installation ground 102. In some embodiments (not shown), the posts 103 are inclined relative to the installation ground 102 and parallel to each other. In other words, the posts 103 are not orthogonal relative to the general plane formed by the installation ground 102.

It is noted that the distal portion 105 is comprised of two segments:
a lower segment anchored in the ground 102; and
an upper segment positioned at a height relative to the lower segment.

In some embodiments, such as that shown in FIG. 1, the photovoltaic module 101 has a securing edge 108 configured to be secured to the posts 103. Preferably, the securing edge 108 is a frame. In other words, the module 101 is preferably a module referred to as “framed”. In some variants, the securing edge 108 of the module has no securing frame, i.e. the module 101 is a module referred to as “frameless”. For example, the system 100 comprises a glass-glass module with no frame.

In some embodiments, at least one means for securing the edge 108 of the photovoltaic module 101 to the post 106 comprises:
at least one bolt and nut assembly,
at least one clip system,
at least one spring, and/or
at least one gripper.

Note that, for the photovoltaic system 100 shown in FIG. 1, the choice of the securing means depends on the mechanical stresses associated with the installation site.

For example, when a bolt and nut assembly is used, two long sides of the photovoltaic module 101 are secured respectively to a first post 103 and a second post 103. In particular, two bolts and two nuts are used for each long side of the photovoltaic module 101. Preferably, one bolt and one nut are positioned, firstly, on the upper portion of the long side of the photovoltaic 101 and, secondly, on the lower portion of the long side of the photovoltaic module 101.

For example, when the system 100 comprises a frameless module 101, the securing means is preferably a set of grippers. These grippers secure each edge 108 of a long side of the module 101 to a post 103. Preferably, the grippers used are clamps. When the module 101 is a frameless glass-glass module, the clamps are directly in contact with the glass of the edge 108 of the module 101. In some variants, such as the one shown in FIG. 47, the securing means 106 has a predetermined thickness configured to form an empty space between a post 103 and a module 101. This thickness corresponds to an intermediate attachment arranged between the post 103 and the module 101. In other words, the post 103 is not directly in contact with the edge 108 of a long side of the module 101. For example, such a securing means 106 is used when the module 101 to be attached is a frameless module.

FIG. 2 shows a schematic view of an embodiment of the system 200 that is the subject of the invention. It is noted that the system 200 shown in FIG. 2 corresponds to a variant of the system shown in FIG. 1. All the embodiments and variants described for the system 100 of FIG. 1 are also valid for the system 200 of FIG. 2, and vice versa. In some embodiments, such as the one shown in FIG. 2, the two posts 103 closest and symmetrical with respect to axis A1 are each a support of two photovoltaic modules 101.

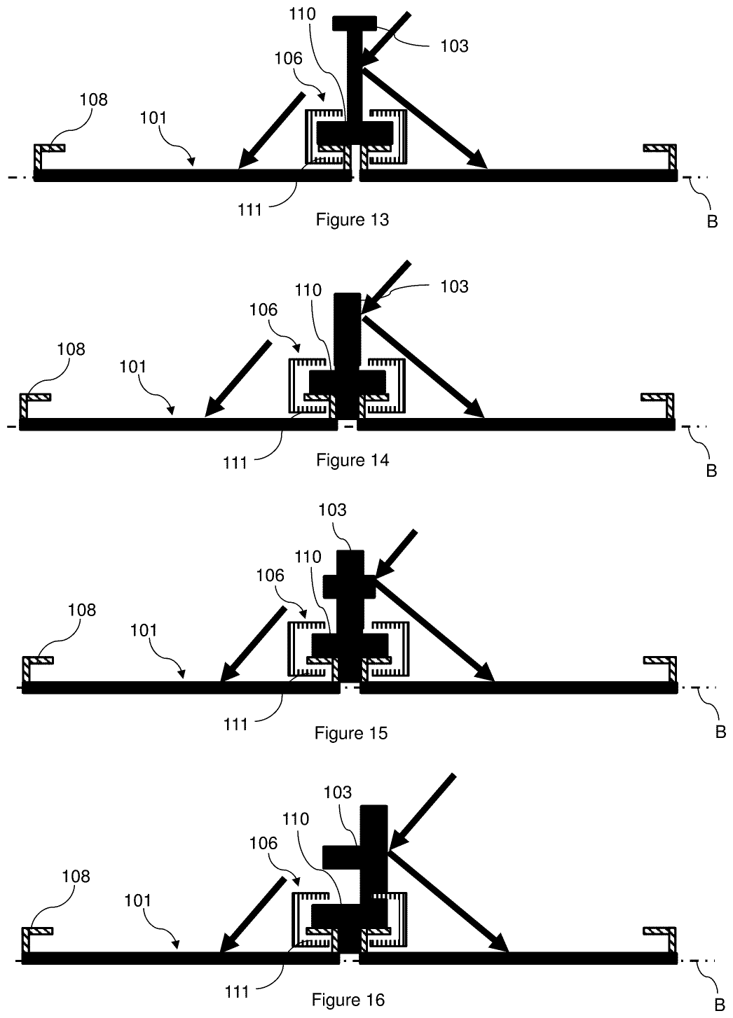

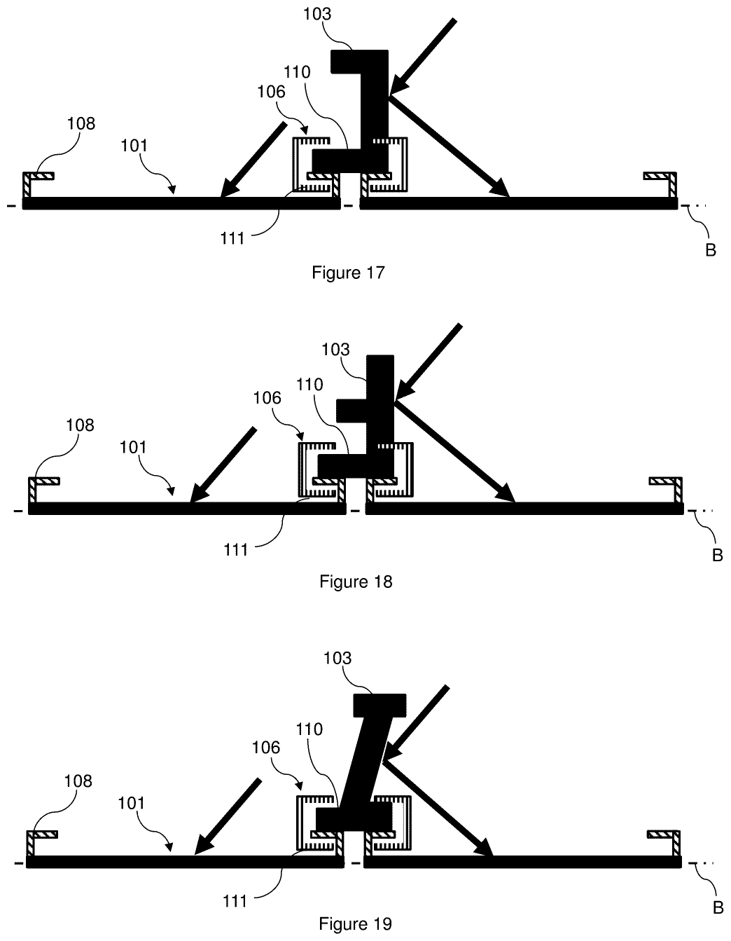

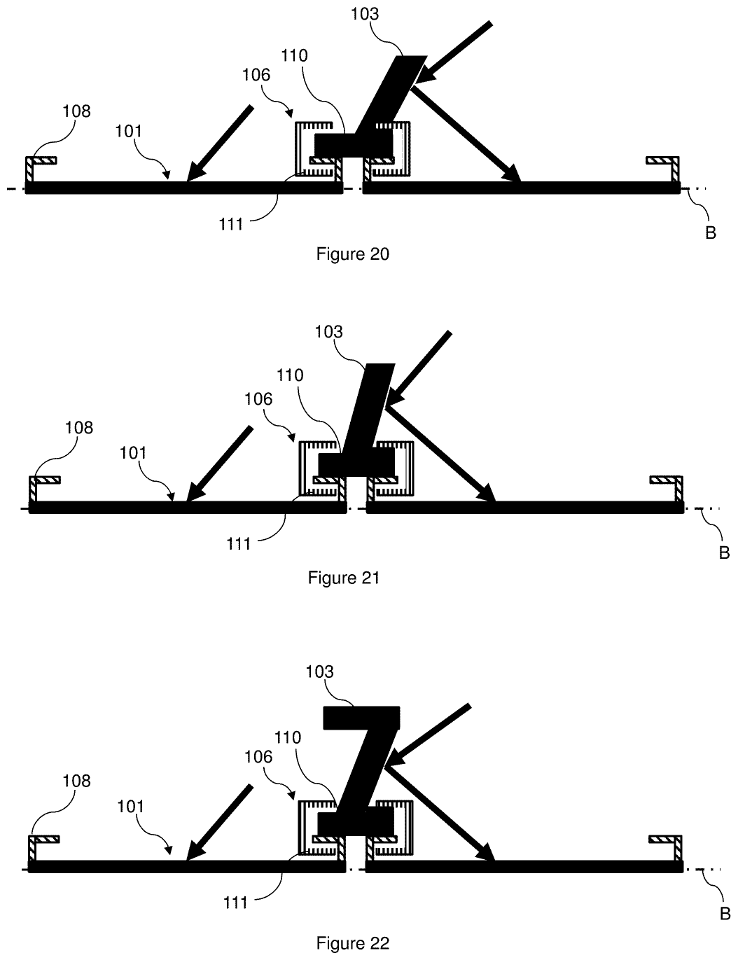

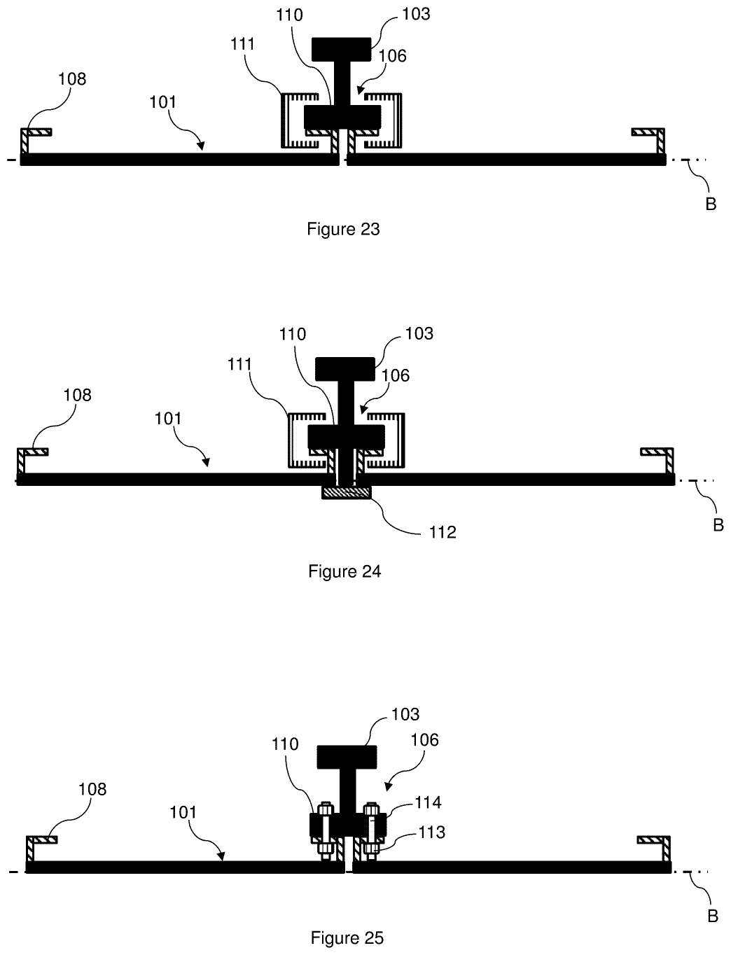

There are several possible embodiments for the shape of the cross-sectional profile of the posts 103 of the system 200 shown in FIG. 2. These different embodiments are shown in FIGS. 11 to 23. In some embodiments, at least one post has a cross-sectional profile with the following shape:
triangle, as shown in FIG. 11;
rectangle, as shown in FIG. 12;
asymmetrical H, as shown in FIG. 13;
symmetrical H, as shown in FIG. 23;
inclined H, as shown in FIG. 19;
cross, as shown in FIGS. 14, 15 and 16;
C, as shown in FIG. 17;
F, as shown in FIG. 18;
inclined T, as shown in FIG. 21;
offset inclined T, as shown in FIG. 20; or
inclined Z, as shown in FIG. 22.

Note that the securing means of each variant associated with a cross-sectional profile of a post 103 comprises an attachment portion 110 of the post 103 configured to attach an edge 108 of the photovoltaic module 101 to the post 103.

In some embodiments, such as those shown in FIGS. 11 to 22, the post is made of a material reflecting light rays. In FIGS. 11 to 22 the light rays are shown by straight arrows. For example, FIG. 11 shows direct light radiation applied on the photovoltaic module 101, and indirect light radiation. The indirect light radiation is the result of the reflection of light radiation applied directly on one of the surfaces of the reflective post 103.

Several embodiments are possible for the securing means of the system 200. These different embodiments are shown in FIGS. 23 to 26.

In some embodiments, at least one securing means 106 for securing the edge 108 of the photovoltaic module 101 to the post 103 comprises:
at least one bolt 114 and nut 113 assembly, as shown in FIG. 25, making it possible, in particular, to prevent the photovoltaic module 101 from detaching and slipping;
at least one clip system 111, making it possible, in particular, to prevent the photovoltaic module 101 from detaching;
at least one spring (not shown); and/or
at least one gripper, for example a clamp 111, as shown in FIG. 23.

Note that the securing means also comprises an attachment portion 110 on the posts 103. The attachment 110 is configured, in combination with, for example, one or more variants of the securing means mentioned previously and shown in FIGS. 23 and 25, for attaching the photovoltaic module 101 to the post 103.

In other embodiments, such as that shown in FIG. 24, the securing means 106 also comprises a front clamp 112. It is noted that the front clamp 112 is compatible with the variants of the securing means mentioned previously and shown in FIGS. 23 and 25.

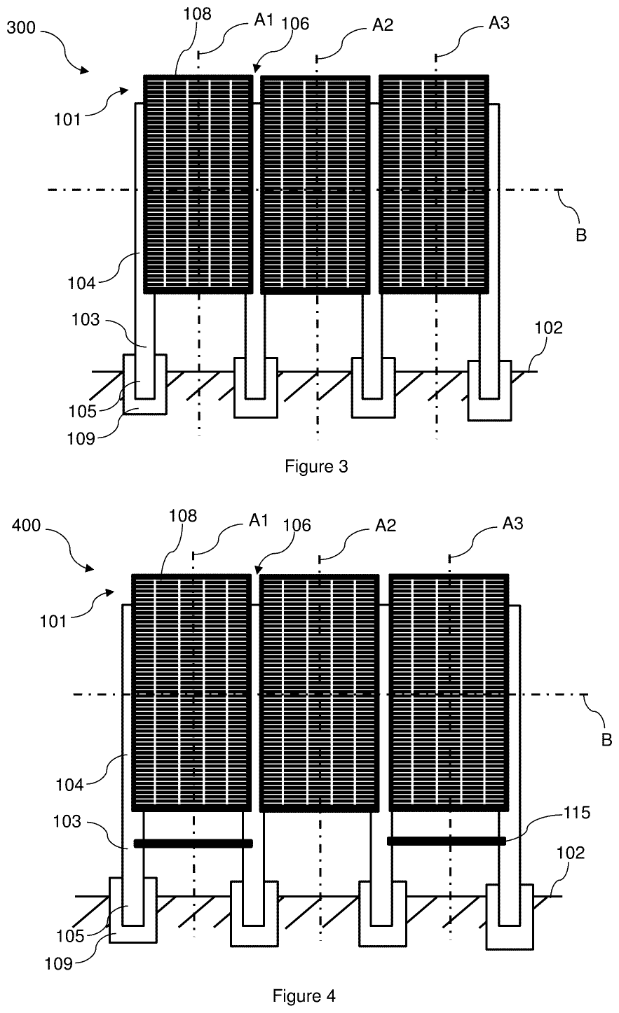

FIG. 3 shows a schematic view of an embodiment of the system 300 that is the subject of the invention. It is noted that the system 300 shown in FIG. 3 corresponds to a variant of the system 200 shown in FIG. 2. All the embodiments and variants described for the systems 100 and 200 of FIGS. 1 and 2 are also valid for the system 300 of FIG. 3, and vice versa.

In some embodiments, such as that shown in FIG. 3, the lower segment of the distal portion 105 of at least one post 103 comprises a block 109. The block 109 is partially or fully anchored in the ground 102 and thus strengthens the adhesion of the post 103 to the ground 102. Note that the adhesion and stabilisation of the post 103 on the ground 102 are achieved by any means known to the person skilled in the art.

In some embodiments (not shown), the lower segment of the distal portion 105 of at least one post 103 has two portions. A first portion is, for example, a stake anchored in the ground 102 and the second portion is secured to the stake. For example, the stake anchored in the ground 102 is at least partially made of metal and/or concrete.

It is noted that the securing of the posts 103 in the ground 102 is, in particular, adjusted to the mechanical stresses of installation. For example, when a post 103 has a stake, the stake is set deeper in the ground 102 in the installation zones subject to strong winds, compared to zones subject to lighter winds.

In some embodiments (not shown), the lower segment of the distal portion 105 of at least one post 103 comprises a weighted stud arranged on the surface of the ground 102.

FIG. 4 shows a schematic view of an embodiment of the system 400 that is the subject of the invention. It is noted that the system 400 shown in FIG. 4 corresponds to a variant of the system 300 shown in FIG. 3. All the embodiments and variants described for the systems 100, 200 and 300 of FIGS. 1, 2 and 3 are also valid for the system 400 of FIG. 4, and vice versa.

In some embodiments, such as that shown in FIG. 4, the device 400 comprises at least one stabilisation means 115 for stabilising the structure formed by at least two posts 103. It is noted that the system 400 also comprises one attachment means, not shown, for attaching the stabilisation means 115 to at least two posts 103.

Preferably, the stabilisation means is a brace 115. The brace 115 is arranged, for example, on the distal portion of the post 103 and below the photovoltaic module 101. It is noted that the brace secured between two successive posts 103 can be realised by any attachment means known to the person skilled in the art. It is noted that the brace 115 is, for example, arranged below one photovoltaic module 101 out of two photovoltaic modules 101, in other words in a discontinuous manner. In this way, the mechanical resistance of the system 400 is improved.

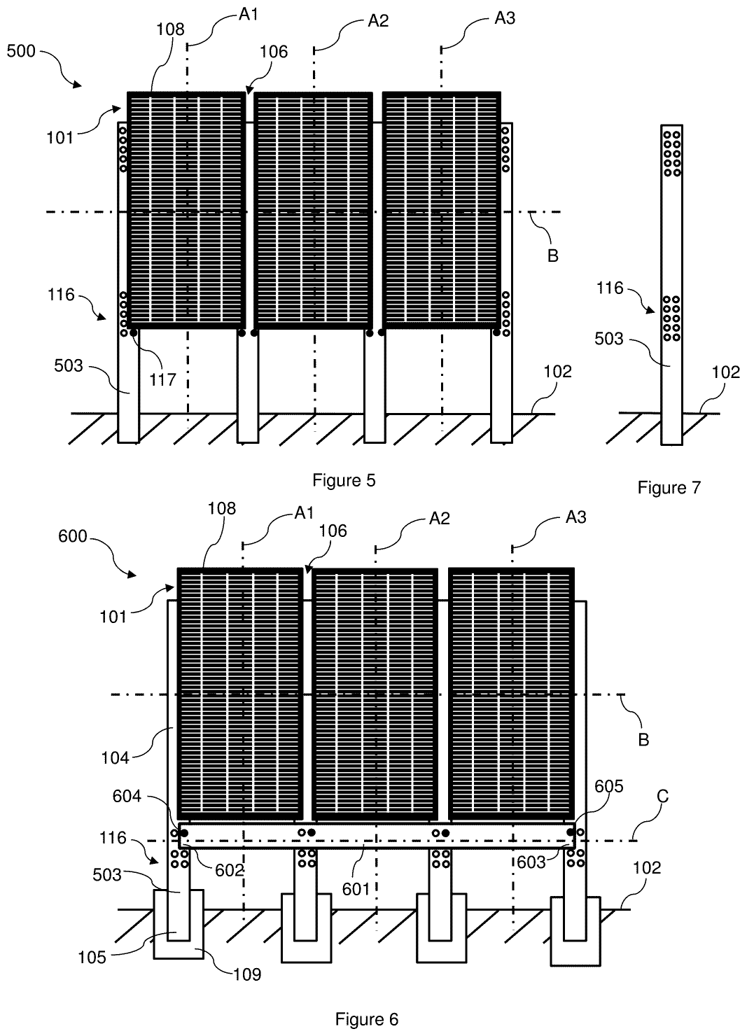

FIG. 5 shows a schematic view of an embodiment of the system 500 that is the subject of the invention. It is noted that the system 500 shown in FIG. 5 corresponds to a variant of the system 200 shown in FIG. 2. All the embodiments and variants described for the systems 100, 200, 300 and 400 of FIGS. 1, 2, 3 and 4 are also valid for the system 500 of FIG. 5, and vice versa.

In some embodiments, such as that shown in FIG. 5, the system 500 comprises at least one post 503 having a set 116 of holes. Preferably, the post 503 used in the system 500 is similar to the post 503 shown in FIG. 7.

It is noted that, for example, when the holes of the set 116 are used to attach the photovoltaic module 101 to the post 503, thus comprised in the securing means 106, a plurality of predetermined positioning heights of the photovoltaic module 101 is available. In other words, at least one securing means 106 has a plurality of attachment positions configured to position a photovoltaic module 101 closer to or farther from the ground 102 according to the attachment position height.

Preferably, the post comprises holes of the set 116 in an oblong shape, configured to adjust the height of the module precisely. In this way, the dimensional tolerance is improved, giving the system 500 a plurality of different installation heights separated by a reduced pitch.

It can be seen on FIG. 5 that the holes of the set 116, arranged under the photovoltaic modules 101, are configured to form a stop system 117. It is noted that such a stop system 117 is comprised in the means for securing the photovoltaic module 101 to the post 503. Preferably, the stop system 117 comprises a pin inserted into a hole of the set 116.

Part of the short side of the photovoltaic module 101 therefore rests on the pin. In this way, the risks of the photovoltaic module 101 slipping, in a downward vertical movement, are limited. Limiting the slippage of the photovoltaic module 101 is especially useful while modules 101 are being mounted on the structure.

It is noted that the plurality of holes in the set 116 of a post 503 makes it possible to insert a pin at different predetermined heights. In this way, the photovoltaic module 101 is secured and stabilised by a stop system 117 that can be adjusted according to the installation requirements of the system 500. In other words, the securing means of the system 500 has a plurality of attachment positions configured to position a photovoltaic module 101 closer to or farther from the ground 102 according to the height of the attachment used.

For example, the distance from or closeness to the ground 102 of the photovoltaic module 101 is realised based on the implantation sites, the electricity production envisaged and/or the vegetation. In other words, based on elements mentioned previously, one can choose to set the lower portion of the photovoltaic module 101 closer to or farther from the ground 102.

For example, the distancing of the photovoltaic module 101 from the ground 102 is realised:
based on the implantation sites, since the distance between the bottom of the photovoltaic module 101 and the ground 102 depends on the slope of the implantation site;
based on the electricity production envisaged, this is because the reflection of light on the ground 102 contributes in particular to a production of electricity that differs according to the height of the photovoltaic modules 101; and
based on the vegetation, since on certain sites there are plants growing and it is not desirable that these plants reach the height of the bottom of the module; this is because the shadow from these plants impairs the sustainability and electricity production of the modules; for example, an initial elevation of the photovoltaic modules 101 is realised so that, between two grass cuts or two harvests, the plants do not reach the height of the lower portion of the photovoltaic modules 101. Preferably, the means of realising the system 500 comprises the set 116 of holes and the stop system 117.

It is noted that the characteristics mentioned previously for the post 503 are also applicable to the post 103 and vice versa.

FIG. 6 shows a schematic view of an embodiment of the system 600 that is the subject of the invention. It is noted that the system 600 shown in FIG. 6 corresponds to a variant of the system 500 shown in FIG. 5. All the embodiments and variants described for the systems 100, 200, 300, 400 and 500 of FIGS. 1, 2, 3, 4 and 5 are also valid for the system 600 of FIG. 6, and vice versa. It is noted that the cross-member corresponds to a variant of the stop system 117 described previously for the device 500 of FIG. 5. In some embodiments, such as that shown in FIG. 6, the system 600 comprises:
at least one cross member 601 arranged under the short side of a photovoltaic module 101 facing the installation ground 102 and having extremities 602 and 603; and
at least two connecting means, 604 and 605, each such connecting means 604 or 605 being configured to secure an individual extremity 602 or 603 of at least one such cross-member to a post 503, this cross-member 601 being arranged and secured between at least two posts 503.

In some embodiments, such as that shown in FIG. 6, there is a single cross-member 601. It is noted that the cross-member has an upper rim directly in contact with the photovoltaic module 101. In these embodiments, the short side of the photovoltaic module 101 therefore rests along the cross-member 601. In this way, the risks of the photovoltaic module 101 slipping downwards are limited, especially during the installation of the system 100.

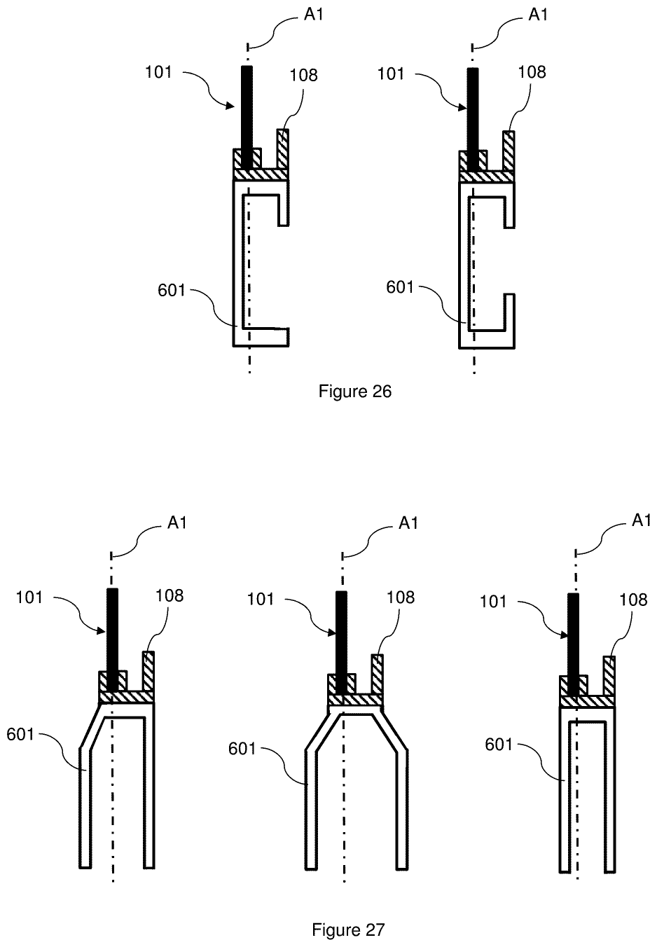

Several embodiments are possible for the shape of the cross-sectional profile of the cross-member 601 of the system 600 shown in FIG. 6. These different embodiments are shown in FIGS. 26 and 27.

In some embodiments, the cross-member 601 of the system 600 has a cross-sectional profile with the following shape:
C, as shown by the two shapes in FIG. 26; or
inverted U, as shown by the three shapes in FIG. 27.

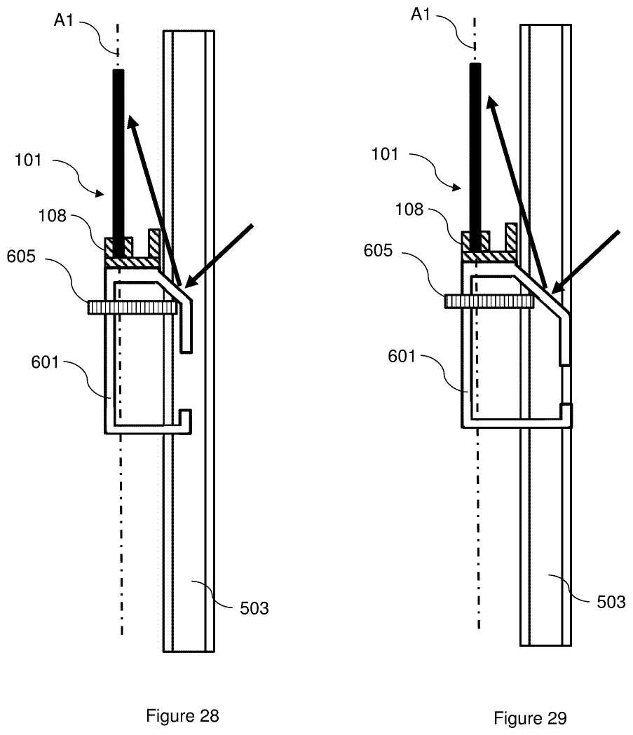

In some embodiments, such as those shown in FIGS. 28 to 30, the cross-member 601 is at least partially made of a light-reflecting material and has a C-shaped cross-sectional profile. In FIGS. 28 to 30 the light rays are shown by straight arrows. For example, FIG. 28 shows indirect light radiation on the photovoltaic module 101. The indirect light radiation is the result of the reflection of light radiation applied directly on a back surface of the reflective cross-member 601.

In some embodiments, such as those shown in FIG. 31, the cross-member 601 also comprises an upper rim in contact with the photovoltaic module 101 and a lower rim configured to hold electrical cables 606 connected to the photovoltaic module 101. Preferably, the lower rim is a track. It is noted that the lower rim is defined by a width and a height.

In some embodiments, such as those shown in FIG. 31, the width of the lower edge of the cross-member 601 shown on the left of FIG. 31 is greater that the widths of the lower edges of the cross-members 601 shown respectively in the centre and on the right of FIG. 31. It can also be seen that the height of the lower edge of the cross-member 601 shown on the right of FIG. 31 is greater that the heights of the lower edges of the cross-members 601 shown respectively in the centre and on the left of FIG. 31.

Preferably, when the modules are connected in series, the positive cable of the photovoltaic modules 101 has a different length, shorter or longer, than the length of the negative cable of the photovoltaic modules 101. Thus, the connectors are protected by the cross-member 601. The modules are connected in series in a chain, referred to as “string”, known to the person skilled in the art. In other words, the positive cable of a first module 101 is connected to a negative cable of a second module 101 by means of a connector. In this configuration, if the positive cable of the first module 103 has a length equal to the length of the negative cable of the second module 103 then the connector of these two cables arrives at the location of the post 103. Such an arrangement of the connector is to be avoided in certain cases, in particular when the cables are positioned in the bottom of the modules 101, i.e. at the location of the short side arranged facing the ground 102. In this case, the connector is not protected by the cross-member 601. Therefore, a difference in the length of the positive cable and the negative cable makes it possible to avoid such an arrangement of the connector and thus enables the connector to be protected by the cross-member 601.

In some embodiments, not shown, the cross-member 601 comprises at least one hole, or a perforated shape, on the upper rim or on a back rim. It is noted that the back rim of the cross-member 601 is on the same side as the junction box of the photovoltaic module 101. The hole of the cross-member 601 is configured to facilitate the passage of the electric cables 606 of the photovoltaic module 101.

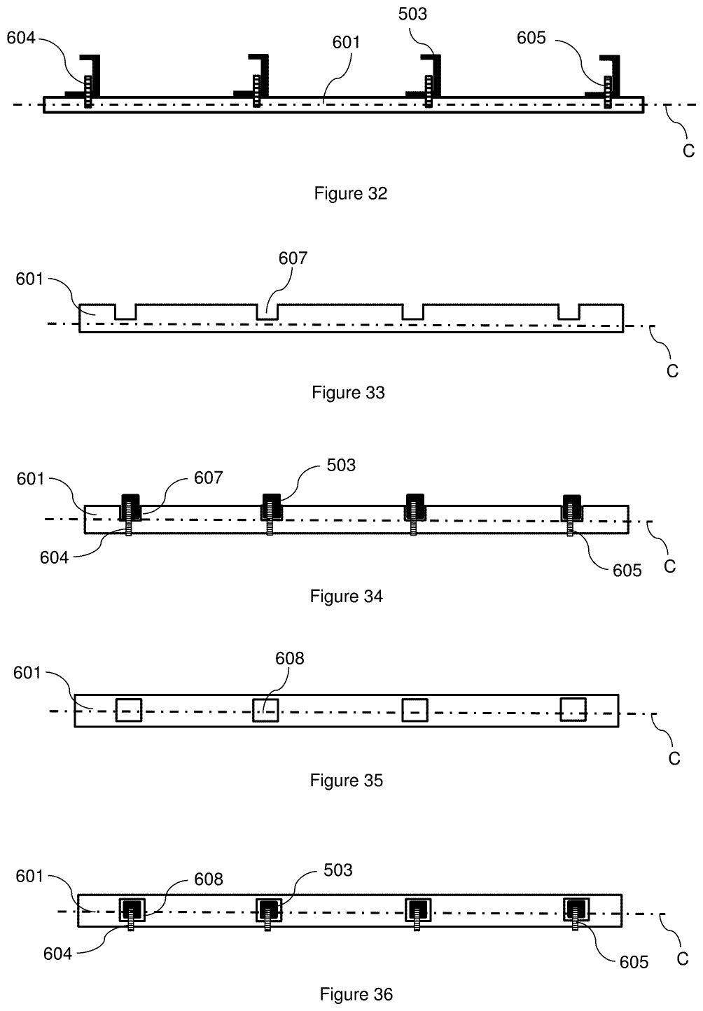

In some embodiments, such as those shown in FIGS. 33 and 35, the cross-member 601 has slots, longitudinal along the axis C and/or transversal along an axis perpendicular to axis C. FIG. 33 shows the longitudinal and transversal slots 607 of the cross-member 601. Note that, in FIG. 34, the slots 607 are configured to partially enclose at least one post 503. FIG. 35 shows the transversal slots 608, along an axis perpendicular to the axis C, of the cross-member 601. Note that, in FIG. 36, the slots 608 are configured to completely enclose at least one post 503. In some embodiments, such as that shown in FIG. 6, the two connecting means, 604 or 605, comprise, for example, bolts, 604 or 605, configured to secure the back rim of the cross-member 601 to the post 503. For example, FIG. 32 shows the cross-member 601 is secured by a set of bolts, and in particular bolts 604 and 605, to posts 503 having a C-shaped cross-sectional profile. In some variants, at least one of the two connecting means, 604 and/or 605, is of the same nature as the first means for securing the edge 108 of the photovoltaic module 101 to the post 103, mentioned previously for the device 100 shown in FIG. 1.

In some embodiments, the heights of the connecting means, 604 and 605, can be adjusted. In this way, the height of the cross-member is adjusted according to the installation constraints of the system 600.

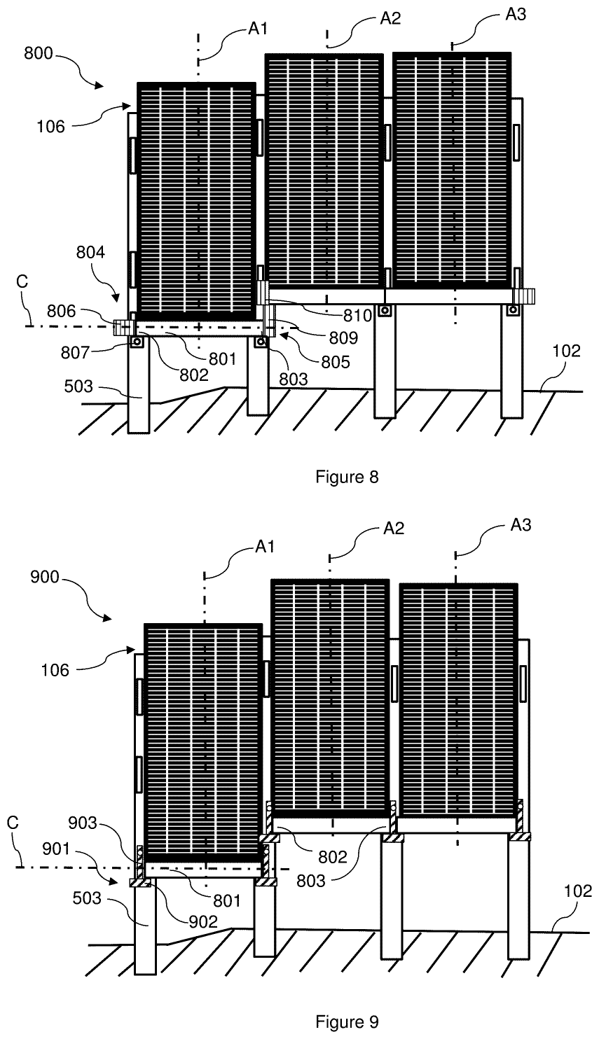

FIG. 8 shows a schematic view of an embodiment of the system 800 that is the subject of the invention. All the embodiments and variants described for the systems 100, 200, 300, 400, 500 and 600 of FIGS. 1, 2, 3, 4, 5 and 6 are also valid for the system 800 of FIG. 8, and vice versa.

It is noted that the system 800 shown in FIG. 8 corresponds to a variant of the system 600 shown in FIG. 6. FIG. 8 shows a plurality of cross-members 801 deployed in the photovoltaic system 800. Thus, several cross-members 801 are used to stabilise the photovoltaic modules 101. Therefore, the height of each cross-member 801 can be set and adjusted according to the height of the photovoltaic modules 101.

In some embodiments, such as that shown in FIG. 8, the system 800 comprises:
at least one cross member 801 arranged under the short side of a photovoltaic module 101 facing the installation ground 102 and having extremities 802 and 803; and
at least two connecting means, 804 and 805, each such connecting means 805 or 804 being configured to secure an individual extremity 802 or 803 of at least one such cross-member to a post 503,

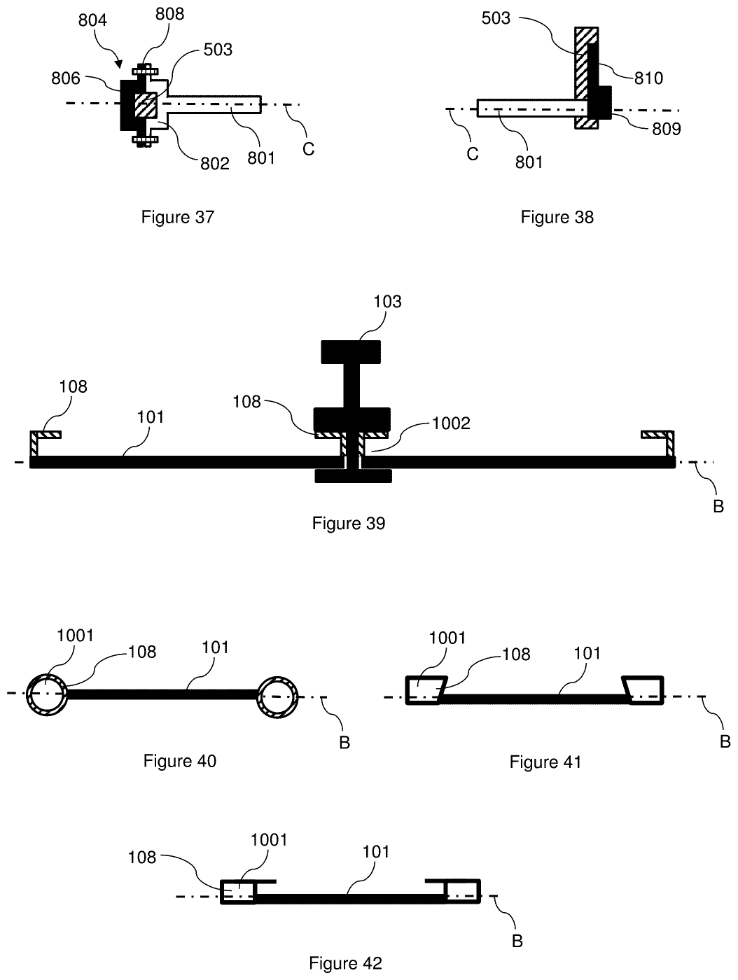

In some embodiments, such as that shown in FIG. 8, one of the two connecting means of the cross-member 801, 804 or 805, comprises an intermediate attachment portion, 806 or 809. FIGS. 8 and 37 show the intermediate attachment portion 806 of the connecting means of the cross-member 804 configured to complete the enclosure of the cross-member 801 around at least one post 503. It is noted that the intermediate attachment portion 806 is arranged on the external portion of the post 503.

FIG. 37 shows that the connecting means comprises, for example, a system of bolts 808 configured to secure at least one part of the intermediate attachment portion 806 with a part of the extremity 802 of the post 503.

Preferably, the intermediate attachment portion 809 is separate from the intermediate attachment portion 806. Therefore, the portion 806 is referred to as the external intermediate attachment portion, and the portion 809 is referred to as the internal intermediate attachment portion. For example, the internal intermediate attachment portion 809, as shown in FIGS. 8 and 38, also comprises an upper portion 810 extending vertically and upwards, along the front face of the post 503.

Preferably, the external intermediate attachment portion 806 is used on at least a last post 103 of a row, in other words at the end of the row of posts 103.

Preferably, the internal intermediate attachment portion 809 presenting the upper portion 810 is used when the two modules 101 secured to the same post have different heights relative to the ground 102. This difference in height is linked, for example, to the presence of a slope formed by the installation ground 102. It is also noted that the internal intermediate attachment portion 809 of the connecting means of the cross-member 804 is configured to complete the enclosure of the cross-member 801 around at least one post 503.

In some embodiments, such as that shown in FIG. 8, one of the two connecting means, 804 or 805, of the cross-member 801, also comprises a moveable adjustment ring 807 configured to adjust the height of an extremity 802 of a cross-member 801. FIG. 8 shows the moveable adjustment ring 807 positioned on the front face of the post 503. In some variants, the moveable adjustment ring 807 is positioned on the external side of the post 503. Preferably, the ring 807 is inserted at the location of the post 503 by close holes. The holes are configured to adjust the height of the ring according to the constraints linked to the installation of the system 800.

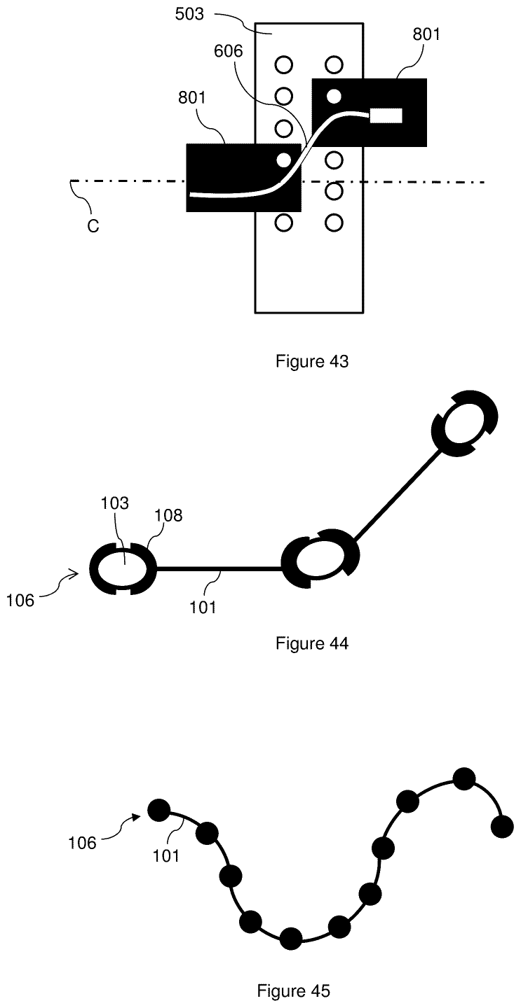

In some embodiments, such as that shown in FIG. 43, the lower portion of the cross-member 801 has, on the extremities 802 and 803, an open cross-sectional profile, configured for an unconstrained passage of the cables 606 when there is a difference of height between two consecutive posts 503. It is noted that, in FIG. 43, the elements 809 and 807 are not shown.

FIG. 9 shows a schematic view of an embodiment of the system 900 that is the subject of the invention. All the embodiments and variants described for the systems 100, 200, 300, 400, 500, 600 and 800 of FIGS. 1, 2, 3, 4, 5, 6 and 8 are also valid for the system 900 of FIG. 8, and vice versa.

It is noted that the system 900 shown in FIG. 9 corresponds to a variant of the systems 600 and 800 shown respectively in FIGS. 6 and 8.

In some embodiments, such as that shown in FIG. 9, at least one connecting means of the system 900 comprises at least one L-shaped intermediate attachment portion 901 comprising:
an upper portion 903, parallel to the long sides of the photovoltaic module 101, and configured to be secured to a post; and
a lower portion 902, perpendicular to the upper portion and to the post, and configured to support the cross-member.

In some embodiments, such as that shown in FIG. 9, the brackets 902 are supports of the extremities, 802 and 803, of a cross-member 801.

In some embodiments, such as that shown in FIG. 9, the bracket 902 is secured to the post 503. Note that the securing of the bracket 902 to the post 503 is achieved by any means known to the person skilled in the art. For example, the securing is achieved by a bolt and nut system configured to secure the post 503 with the upper part of the upper portion 903 of the bracket 902.

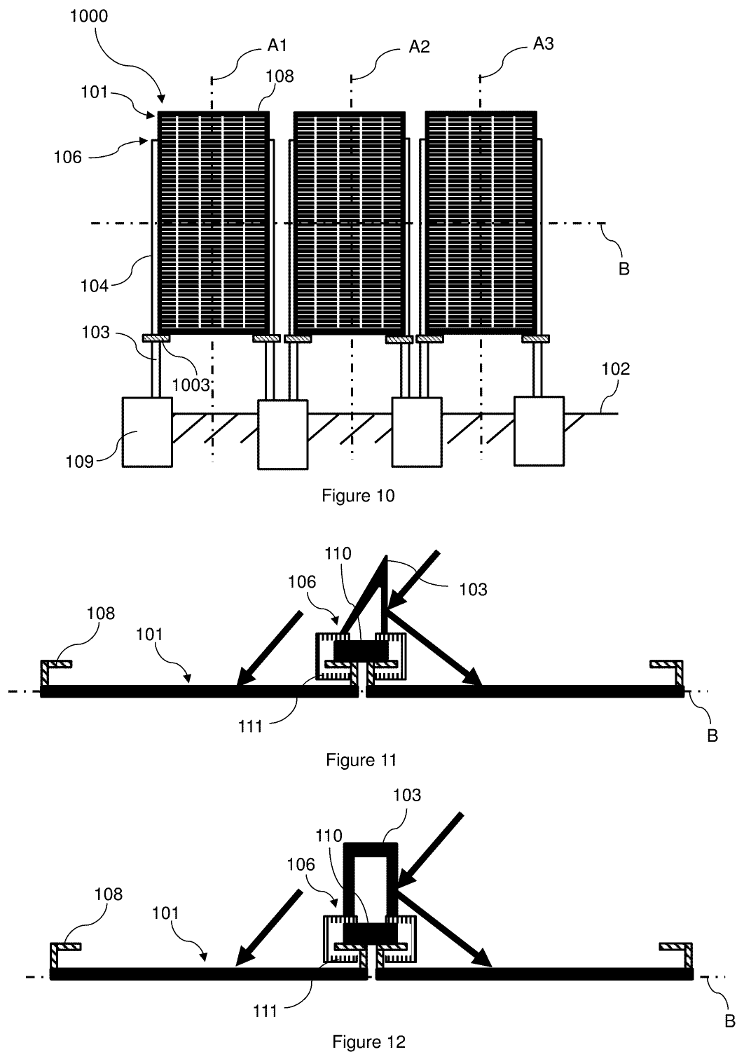

FIG. 10 shows a schematic view of an embodiment of the system 1000 that is the subject of the invention. All the embodiments and variants described for the systems 100, 200, 300, 400, 500, 600, 800 and 900 of FIGS. 1, 2, 3, 4, 5, 6, 8 and 9 are also valid for the system 1000 of FIG. 10, and vice versa.

It is noted that the system 1000 shown in FIG. 10 corresponds to a variant of the system 100 shown in FIG. 1. In some embodiments, such as that shown in FIG. 10, the securing means 106 between at least one post 103 and at least one photovoltaic module 101 is a sliding link type.

In some embodiments, the securing edge 108 of a photovoltaic module 101 comprises a longitudinal hollow 1001, as shown in FIGS. 40 to 42, configured for introducing the post 103 by sliding. In other words, the longitudinal hollow 1001 of the securing edge 108 corresponds to the “female” portion and the post 103 corresponds to the “male” portion. For example, when the securing edge 108 is a frame, the frame comprises the longitudinal hollow 1001. Note that the shape of the post 103 is compatible with the geometry and dimensions of the longitudinal hollow 1001, thus the post 103 is configured to be introduced into the hollow 1001.

Preferably, the longitudinal hollow 1001 of a frame 108 has a substantially semi-circular shape and the cross-section of the post 103 has a substantially circular shape. It is noted that the two circular elements have a longitudinal axis of rotation. In other words, the two circular elements form a pivot link configured to produce bends between each module 101, as shown in FIG. 44. In this way, a plurality of spatial configurations of successive systems 1000 is realised. The different configurations are, for example, curves as shown in FIG. 45.

In some embodiments, such as those shown in FIG. 39, the post 103 comprises a longitudinal hollow 1002 configured for introducing the securing edge 108 into the post 103 by sliding. In other words, the longitudinal hollow 1002 of the post 103 corresponds to the “female” portion and the edge 108 corresponds to the “male” portion. Note that the shape of the edge 108 is compatible with the geometry and dimensions of the longitudinal hollow 1002, thus the edge 108 is configured to be introduced into the hollow 1002.

In some embodiments, such as that shown in FIG. 10, there is a stop system 1003 in the system 1000, which is configured to hold the edge 108 of the photovoltaic module 101 at a predetermined height of post 103. In other words, the securing means 106 has a plurality of attachment positions configured to position a photovoltaic module 101 closer to or farther from the ground 102 according to the attachment position height.

In some embodiments, such as those shown in FIGS. 1 to 6 and 8 to 10, the systems, 100, 200, 300, 400, 500, 600, 800, 900 and 1000, comprise no horizontal structural element connecting two posts, 103 and/or 503, for example a girder, cross-member, brace or strut, arranged above the short side of a photovoltaic module farthest from the installation ground.

It is noted that the systems, 200, 300, 400, 500, 600, 800, 900 or 1000, shown respectively in FIG. 3, 4, 5, 6, 8, 9 or 10 correspond to variants of the system shown in FIG. 1. All the embodiments and variants described for the system 100 of FIG. 1 are also valid for the systems, 200, 300, 400, 500, 600, 800, 900 or 1000 respectively of FIG. 2, 3, 4, 5, 6, 8, 9 or 10, and vice versa.

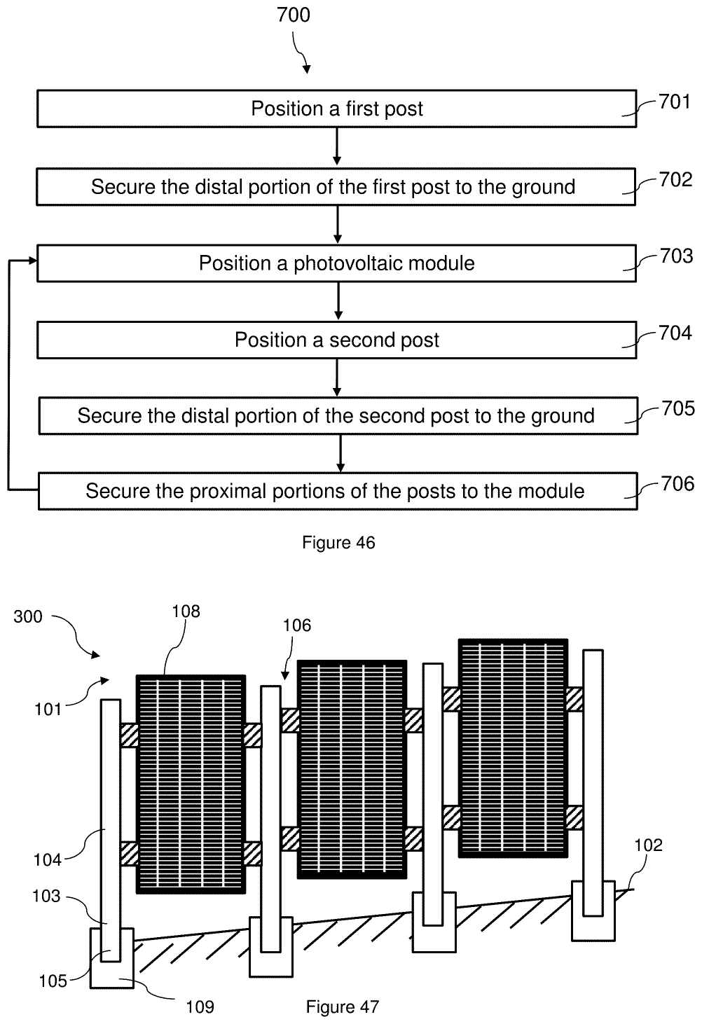

FIG. 46 shows a schematic view of an embodiment of the method 700 that is the subject of the invention. The method 700 for installing a vertical photovoltaic system comprises:
a step 701 of positioning at least a first support post for supporting a photovoltaic module, at least one such first post having:
a distal portion, and
a proximal portion;
a step 702 of securing the distal portion of at least one such first post to the ground;
a step 703 of positioning at least one bifacial rectangular photovoltaic module, each such photovoltaic module having:
two sides, referred to as “short sides”, and
two other sides, referred to as “long sides”, the length of which is greater than or equal to a length of at least one short side;
a step 704 of positioning at least a second support post for supporting a photovoltaic module;
a step 705 of securing a distal portion of at least one such second post to the ground; and
a step 706 of securing each proximal portion of two such consecutive posts to each long side of at least one such photovoltaic module, each photovoltaic module thus being directly connected, via its two long sides, to the securing means of two consecutive support posts.

Note that, in these embodiments, the second post also comprises a distal portion and a proximal portion. During the steps of positioning two posts, 701 and 704, each post is positioned so as to differentiate between:
the proximal portion, subsequently secured to a photovoltaic module; and
the distal portion, subsequently secured to the ground.

During the step 704 of positioning a second post, the positioning is carried out based on the positioning of the photovoltaic module. During the steps of securing posts, 702 and 705, each distal portion of the posts is secured to the ground using any securing method known to the person skilled in the art. During the step 703 of positioning a module, the photovoltaic module is oriented such that a short side is arranged facing the ground when the photovoltaic system is in the installed position.

During the securing step 706, each proximal portion of the two posts is secured to each long side of the photovoltaic module by using, for example, the securing means mentioned previously for the different embodiments of the photovoltaic system.

In some embodiments, the steps of positioning 701 and securing 702 the first post are simultaneous. In some embodiments, the steps of positioning 704 and securing 705 the second post are simultaneous.

In some embodiments, the step 703 of positioning at least one photovoltaic module also comprises a step of using at least one template. It is noted that the template is equivalent to a “dummy” module. During the step of using a template, the template is positioned on the first post secured to the ground. In these embodiments, the step 704 of positioning a second post for supporting a photovoltaic module is carried out based on the positioning of the template on the first post. In other words, the step of using a template guides the positioning of the second post. In particular, the use of a template determines a distance between two posts based on the length of the short sides of the module. In addition, during the step of using a template, all the posts in a row of posts are aligned in the same plane. In some variants, the use of a template defines a position on the ground for the support of the second post, thus determining the position of the second post. It is noted that, before the step 704 of positioning the second post, the template is removed from the installation, and this removal is followed by the step 706 of securing the photovoltaic module to the two posts positioned and secured to the ground. In some variants, a template assists in the positioning of several posts without this template being moved.

In some embodiments, the method 700 comprises at least one iteration of the steps 703, 704, 705 and 706. In other words, the steps 703, 704, 705 and 706 of the installation method 700 are repeated through to complete installation of the vertical photovoltaic system.

Preferably, the means of the devices, 100, 200, 300, 400, 500, 600, 800, 900 and/or 1000, are configured to implement the steps of the method 700 and their embodiments as described above, and the method 700 and its different embodiments can be implemented by the means of the device 100, 200, 300, 400, 500, 600, 800, 900 and/or 1000.

In some embodiments, at least one securing means and at least one photovoltaic module support post are used for installing at least one vertical photovoltaic system.

1. A vertical photovoltaic system comprising:
at least one bifacial rectangular photovoltaic module, each module having:
two sides, referred to as “short sides”,
two other sides, referred to as “long sides”, the length of which is greater than or equal to a length of at least one short side;
at least two support posts for supporting the photovoltaic module, each such post having:
a first portion configured to be secured to at least one such photovoltaic module;
a second portion configured to be secured to the ground; and
at least one securing means for securing at least one such post to the long side of at least one such photovoltaic module;
each photovoltaic module being directly connected, via its two long sides, to the securing means of two consecutive support posts.

2. The system according to claim 1, which comprises no horizontal structural element, connecting two posts, arranged above the short side of a photovoltaic module farthest from the ground.

3. The system according to claim 1, wherein at least one securing means has a plurality of attachment positions configured to position a photovoltaic module closer to or farther from the ground according to the attachment position height.

4. The system according to claim 1, wherein at least one securing means comprises:
at least one bolt and nut assembly,
at least one clip system,
at least one spring, and/or
at least one gripper.

5. The system according to claim 1, wherein at least one post has a cross-sectional profile with the following shape:
symmetrical or asymmetrical H;
inclined H;
cross;
C;
F;
inclined T;
offset inclined T; or
inclined Z.

6. The system according to claim 1, which comprises:
at least one cross member arranged under the short side of a photovoltaic module closest to the installation ground, and having extremities; and
at least two connecting means, each such connecting means being configured to secure an individual extremity of at least one such cross-member to a post,
this cross-member being arranged and secured between at least two posts.

7. The system according to claim 6, wherein at least one cross-member has a C- or inverted U-shaped cross-sectional profile.

8. The system according to claim 6, wherein at least one cross-member is configured to at least partially enclose at least one post.

9. The system according to claim 6, wherein at least one cross-member comprises an upper rim in contact with the module and a lower rim configured to hold electrical cables connected to the photovoltaic module.

10. The system according to claim 8 wherein at least one connecting means comprises at least one intermediate attachment portion configured to complete the enclosure around at least one post.

11. The system according to claim 6, wherein
at least one connecting means comprises at least one L-shaped intermediate attachment portion comprising:
an upper portion, parallel to the long sides of the module, and configured to be secured to a post; and
a lower portion, perpendicular to the upper portion and to the post, and configured to support the cross-member.

12. The system according to claim 1, wherein the securing means between at least one post and at least one photovoltaic module is a sliding link type.

13. The system according to claim 1, wherein at least one post and/or at least one cross-member is at least partially made of a light-reflecting material.

14. A method for installing a vertical photovoltaic system, characterised in that it comprises:
a step of positioning at least a first support post for supporting a photovoltaic module, at least one such first post having:
a distal portion, and
a proximal portion;
a step of securing the distal portion of at least one such first post to the ground;
a step of positioning at least one bifacial rectangular photovoltaic module, each such photovoltaic module having:
two sides, referred to as “short sides”, and
two other sides, referred to as “long sides”, the length of which is greater than or equal to a length of at least one short side;
a step of positioning at least a second support post for supporting a photovoltaic module;
a step of securing a distal portion of at least one such second post to the ground; and
a step of securing each proximal portion of two such consecutive posts to each long side of at least one such photovoltaic module,
such that each photovoltaic module is directly connected, via its two long sides, to the securing means of two support posts.

15. A use of at least one securing means and at least one support post for supporting a photovoltaic module for installing at least one vertical photovoltaic system according to claim 1.
